(19) United States
(12) Patent Application Publication
(10) Pub. No.: US 2003/0229961 A1
(43) Pub. Date: Dec. 18, 2003

(54) Wiper blade

(76) Inventor: Roger Barnett, Buffalo, NY (US)

Correspondence Address: Maria S. Olson, The Gates Corporation, MS: 31-4-1-A3, 900 South Broadway, Denver, CO, 80209, US

(21) Appl. No.: 10/462,317

(22) Filed: Jun. 13, 2003

Related U.S. Application Data
(60) Provisional application No. 60/388,973, filed on Jun. 14, 2002.

(51) Int. Cl. B60S 1/38

(52) U.S. Cl. 15/250.48

(57) ABSTRACT

A wiper blade comprising an elongate cured rubber body having an upper grooved portion adapted for engagement with a backing member for maintaining the wiper blade in position; a base portion disposed along the grooved portion and comprising a wiping surface lip portion defining the apex of the base portion; and at least one strip extending along at least one side of the wiping surface lip portion, the strip portion comprising a vulcanized composition formed of a base rubber and from about 1 to about 10 phr of a friction reducing element.

### CROSS-REFERENCE TO RELATED APPLICATIONS

This application claims the benefit of U.S. patent application Ser. No. 60/388,973, filed Jun. 14, 2002, now abandoned.

### BACKGROUND OF THE INVENTION

1. Field of the Invention

The present invention is directed to an improvement in a wiper blade, and particularly a wiper blade possessing a rubber body portion comprising a wiping surface portion and a reduced coefficient of friction portion.

2. Description of the Related Art

Wiper blades, and specifically windshield wiper blades for moving slidably across the glass windshield of an automobile or the like to remove water droplets on the surface of the glass have been the subject of development variously in order to improve the rubber base portion and/or wiping surface properties such as flexibility, weather resistance, sliding resistance, wear resistance and combinations thereof. Wiper blades generally comprise an elongate generally rubber body having a base portion adapted for engagement with a harness—or beam—or any other conventional or suitable backing member for engagement of the wiper blade to a wiper arm mechanism for maintaining the wiper blade in position against the glass surface, and at least one wiping surface portion generally defining the apex and immediately surrounding area of the base portion. A beam mechanism as mentioned above is disclosed in U.S. Pat. No. 5,325,564, to Swanepoel, the contents of which with respect to same is hereby incorporated by reference.

As the generally flexible wiper blade slidably moves across the windshield surface in operation, generally contacting a more or less even distribution of moisture accumulated thereon, the wiping surface generally at the apex of the wiper blade's base portion drags rearwardly, or deflects, to a degree determined by a combination of factors including the flexibility of the base portion, the level of moisture contacted by the blades' wiping surface at any given point and any given moment and the ability of the windshield wiper assembly, including both the wiper blade itself and the rigid generally spring-loaded mechanical device to which it is engaged, to maintain a suitable normal force across the windshield geometry. This deflection of the base portion causes the specific area of the wiping surface portion that is in contact with the glass surface at any given point in the operation of the wiper assembly to change, and can lead to an undesirable stick-slip phenomenon, i.e., non-constant motion or engagement of the wiping surface across the windshield, oftentimes with skipping of the blade, and concomitant nonuniform wiping action.

Conventionally, wiper blade bodies are formed of vulcanized rubber compositions comprising natural rubber (i.e., both natural- and synthetic polyisoprene) (NR), chloroprene rubber (CR), ethylene propylene copolymer (EPM) or -terpolymer (EPDM), styrene butadiene rubber (SBR), acrylonitrile butadiene rubber (NBR) or a blend of any two or more of the foregoing.

The use of a wiping blade having a smooth textured wiping lip that is effective on a wet glass and a different textured flat rubber surface on each side thereof produced by a mechanical treatment, and which possess infinitesimal projections thereon to decrease its adhesion when brought into contact with a partially wet glass is disclosed in U.S. Pat. No. 3,040,359 to Deibel. It is furthermore known to incorporate in the wiper body spaced from but extending along either side of the wiping surface portion a strip comprising a vulcanized composition formed of NBR, being a base rubber other than that comprising the blade's base portion and/or wiping surface portion, and a friction reducing system comprising a combination of polytetrafluoroethylene in low but effective amounts of less than 1 part per hundred weight of rubber (phr), and minor- to equal amounts, i.e., from about 20 to about 50 phr of a plastic, i.e., polyvinyl chloride (PVC), in order to present a decreased coefficient of friction surface on either side of but spaced from the primary wiping surface or lip, optionally having irregularities formed by the plastic particles within the elastomer composition. As the wiper blade deflects in operation due to low- or uneven moisture levels on the windshield surface, at least a portion of this decreased coefficient of friction strip comprising PVC and the second base rubber contacts the windshield surface with the effect of presenting a reduced drag windshield-contacting surface. While this combination proved highly effective under most operating conditions, at ambient temperatures at or below 5° C., it was found that the lower coefficient of friction strip exhibited some stiffening, i.e., decreased flexibility, as a result of the presence of the plastic in the elastomer composition, with adverse effect on the blade's performance at such temperatures.

U.S. Pat. No. 4,622,712 to Sugita et al teaches the incorporation of large amounts of a low particle diameter lubricant, i.e., 10 to 50 percent by volume of molybdenum disulfide or the like having particle diameter of 0.1 to 1.0μ, in the rubber forming the lip portion, i.e., the wiping surface portion, of a wiper blade. Again however, patentees acknowledge that blending of a lubricant with rubber causes an undesirable decrease in flexibility of the rubber, thus presenting the same aforementioned undesirable consequences, particularly at decreased operating temperatures.

### SUMMARY OF THE INVENTION

The present invention provides a wiper blade comprising an elongate generally rubber body having a base portion adapted for engagement with a backing member for maintaining the wiper blade in position; a wiping surface lip portion generally defining the apex of the base portion; and at least one strip extending along at least one side of the wiping surface lip portion and optionally spaced from the base portion apex, comprising a vulcanized composition formed of a base rubber, which in an embodiment of the present invention is a rubber substantially the same as that of the base portion, and from 1 to less than 10 phr of a friction reducing element.

In a further embodiment a wiper blade as described above is provided, wherein the friction reducing element forms a plurality of protuberances or indentations on the surface of the strip for reducing the surface contact between the strip and the windshield surface with deflection of the blade.

In yet a further embodiment of the present invention, a wiper blade assembly, comprising a wiper blade as described above connected to a backing member, optionally detachably connected to a wiper arm, is provided.

### BRIEF DESCRIPTION OF THE SEVERAL VIEW OF THE DRAWINGS

In the drawings, like numerals denote like parts, and,

FIG. 1 is a cross sectional perspective view of a portion of a wiper blade in accordance with an embodiment of the present invention;

FIG. 2 is an expanded view of a portion of the wiper blade of FIG. 1;

FIG. 3 is a cross sectional perspective view of a portion of a wiper blade in accordance with a further embodiment of the present invention; and

FIG. 4 is a cross sectional view of a wiper blade in combination with a backing member in accordance with a further embodiment of the present invention.

### DETAILED DESCRIPTION

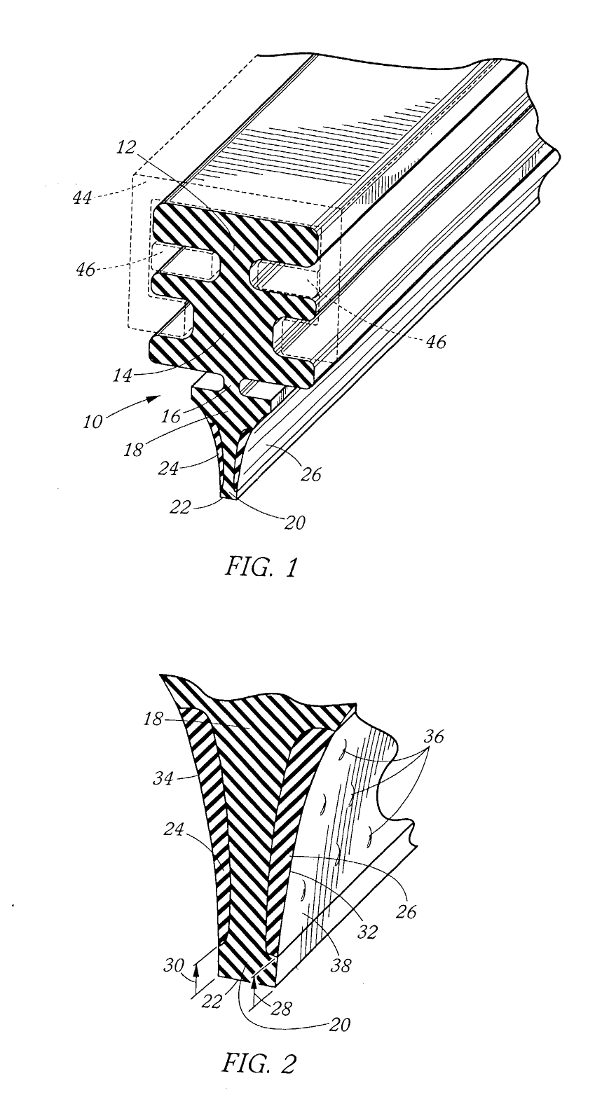

Referring to FIGS. 1 and 2 a wiper blade 10 in accordance with an embodiment of the present invention is illustrated in cross section. The outer cross-sectional shape of the wiper blade of the present invention may be of any conventional and/or suitable variety, and may be utilized with any conventional and/or suitable backing member, including but not limited to a conventional yoke- and vertebrae combination harness-type backing member as shown in phantom in FIG. 1, and a beam-type blade mechanism disclosed in aforementioned U.S. Pat. No. 5,325,564, the contents of which with respect to such constructions is hereby specifically incorporated. The wiper blade 10 comprises an elongate body 12 having a backing member-engaging grooved portion 14 of any conventional or suitable configuration for engagement with a suitably configured split-rail vertebrae 46 and harness or yoke 44 rigid piece (shown in phantom in FIG. 1) formed of plastic, steel or the like, a hinge portion 16, a base portion 18 and a wiping surface lip portion 20 at the apex 22 of the base portion 18 as shown.

As is well recognized in the art, the base portion 18 possesses a generally triagonal cross sectional shape and is connected to the backing member-engaging grooved portion 14 by means of the thin hinge portion 16 disposed therebetween. The base portion 18 generally deflects relative to the backing member-engaging grooved portion 14 with sliding movement of the wiper blade 10 forward and rearward on the glass surface upon operation of the wiper assembly, causing a greater- or lesser portion of the wiping surface lip portion 20, and in instances of greater deflection, the area adjacent thereto to come into contact with the windshield surface

In the illustrated embodiment of FIGS. 1 and 2, the wiper blade 10 further comprises a strip 24, 26 extending along at least a portion of the length of the base portion 18, one each on either side of the wiping surface lip portion 20 and optionally spaced from the apex 22 by a distance 28, 30 as shown. The strip 24, 26 adjoins the wiping surface lip portion 20 either substantially directly as shown in FIGS. 1 and 2 or alternatively through a slight shoulder. The latter configuration is illustrated for example in aforementioned U.S. Pat. No. 3,040,359, e.g., in FIG. 5 thereof, the contents of which disclosure with respect to same is hereby incorporated by reference. Alternatively however, the strip may extend substantially down to the apex 22. When two strips 24, 26 are incorporated in the wiper blade 10 as shown in FIG. 1 however, the distances 28, 30 may be substantially the same as or different from one another, but in the illustrated embodiment, are substantially the same as one another. In an alternative embodiment, only one such strip may be present on the wiper blade. In addition to extending along any suitable or conventional length of the wiper blade including extending along substantially the entire length of the wiper blade 10, the strip 24, 26 possesses a height extending along at least a portion but generally less than the entire height of each lateral surface 32, 34 of the base portion 18, and a thickness.

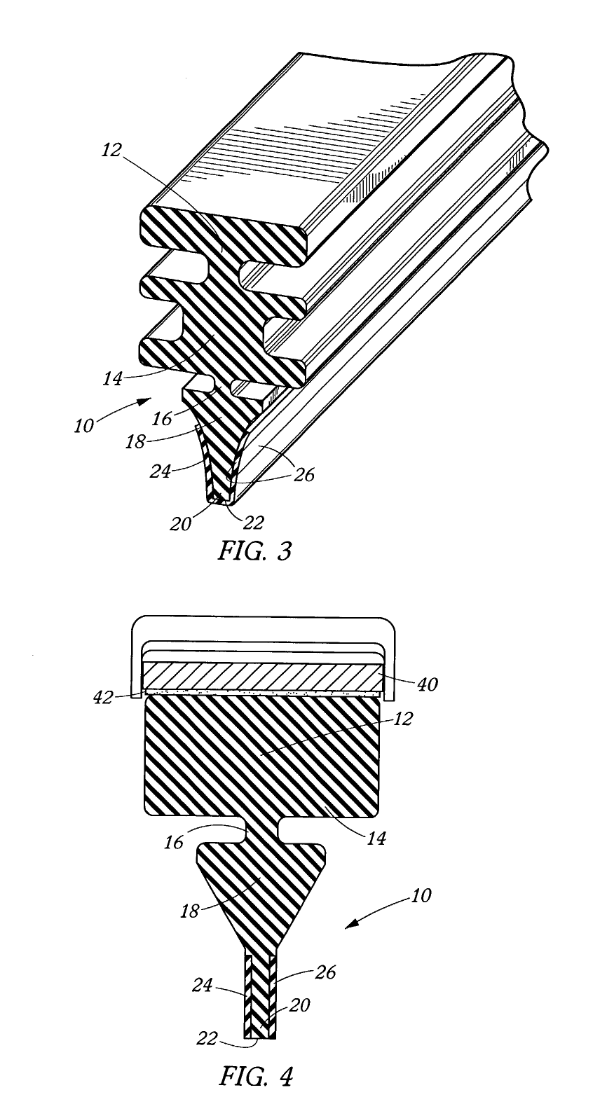

In various embodiments of the present invention in addition to those illustrated in the Figures and described above, the strips 24, 26 may have a height in the range of from about 0.25 mm to about 3.5 mm; or alternatively in the range of from about 0.5 mm to about 3.0 mm, or alternatively in the range of from about 1.0 mm to about 2.0 mm. In further embodiments of the present invention, the strips 24, 26 may have a thickness in the range of from about 0.05 mm to about 0.75 mm; or alternatively in the range of from about 0.075 mm to about 0.50 mm; or alternatively in the range of from about 0.095 mm to about 0.25 mm. In yet a further embodiment of the present invention, particularly wherein the strips 24, 26 extend down to and about the apex 22, the reduced coefficient of friction rubber composition may extend across the entire width of the base portion 18. The strips 24, 26 may moreover have any suitable or desirable shape, such as slightly tapered as shown in FIG. 1, or substantially rectangular as illustrated in FIG. 3.

In an embodiment of the present invention, any or each of the backing member -engaging grooved portion 14, the hinge portion 16, the base portion 18 and the wiping surface portion 20 are formed of a vulcanized or cured composition of a flexible rubber, which for example may be selected from natural rubber (including synthetic polyisoprene), chloroprene rubber, styrene butadiene rubber, ethylene alpha olefin elastomer, polybutadiene, silicone rubber, acrylonitrile butadiene rubber, hydrogenated acrylonitrile butadiene rubber, urethane and a combination of any two or more of the foregoing. In the compositions of flexible rubber making up one or more parts of the wiper blade of the present invention, conventional rubber composition additives may be employed in any suitable and/or conventional amount. Thus for example the composition may include as optional constituents one or more reinforcing-, semi-reinforcing or non-reinforcing fillers such as carbon black, silica, talc or clay in amounts of up to, e.g., 250 phr, or alternatively up to 150 phr or up to 75 phr. One of ordinary skill in the relevant art would readily recognize that where a dual-color scheme is employed in the wiper blade construction, e.g., a black body portion 12 and a gray- or whitish strip 24, 26, carbon black may be utilized as at least one of the fillers in the elastomeric composition forming the body portion 12 while one or another of a clay, silica or talc filler may be employed as at least one of the fillers in the composition of the strip 24, 26. In addition to a filler, the compositions for the body portion 12 and the strip 24, 26 may furthermore include as optional constituents for example one or more plasticizers and/or process aids such as polybutadiene; antidegradants and/or antiozonants such as multi-functional hindered phenols, magnesium hydroxide and/or petroleum waxes; activators such as zinc- or other metal oxides and/or stearic acid; and curatives such as sulfur, a free-radical producing agent such as peroxide or combinations thereof, optionally in combination with one or more accelerators; all in amounts conventionally employed.

As the material for the strip 24, 26 the same or a different cured- or vulcanized flexible rubber composition as described above for any of the backing member-engaging grooved portion 14, hinge portion 16, base portion 18 and wiping surface lip portion 20 may be employed, with the exception that in addition to the composition constituents described, the material for use as the strip 24, 26 comprises a friction reducing element in an amount of from about 1 to about 15 phr, or alternatively of from about 1.5 to about 10 phr, or alternatively of from about 2 to about 8 phr. As the friction-reducing element, particulate fluoro polymers such as polytetrafluoroethylene (PTFE), molybdenum disulfide and graphite may be employed either singly or in a combination of any two or more thereof. The friction reducing element may have any average particle diameter, or alternatively may have an average particle or particle agglomerate diameter of at least 1 μm, or of from about 5 μm to about 100 μm, or of from about 10 μm to about 50 μm. Specific examples of materials fitting this description include PTFE available from DuPont Chemical Co. under the references ZONYL 1300 and ZONYL 1500J.

In the practice of an embodiment of the present invention, a wiper blade as illustrated in FIG. 1 was formed, having an elongate body 12, including a backing member-engaging grooved portion 14, hinge portion 16, base portion 18 and wiping surface lip portion 20 all formed of a single first elastomer composition comprising a conventional vulcanized carbon-black filled natural rubber composition. A particulate PTFE having an average particle agglomerate diameter of about 20 μm, a particle agglomerate diameter range of generally from about 10 μm to about 35 μm, available from DuPont Chemical under the reference ZONYL MP1500J was employed as the friction reducing element of the strip, at a concentration of 5 phr in a vulcanized natural rubber composition formed of a natural rubber latex and further comprising as optional constituents a bonding system for facilitating incorporation of the PTFE in the elastomer, comprising 2 phr of a bonding agent available from Uniroyal Chemical under the reference, R6, and 3 phr of a second bonding agent also available from Uniroyal Chemical, under the reference, CYREZ 963P. In addition, the composition for the strip 24, 26 comprised as optional constituents 75 phr of a clay filler, and less than 10 phr each of an NR-compatible desiccant for reducing the moisture absorption of the clay-filled composition, an NR-compatible conventional activator system, an NR-compatible conventional antioxidant/antiozonant system, a polybutadiene process aid and an NR-compatible conventional colorative. The composition curative was sulfur in combination with a conventional sulfur cure accelerator, at 4.7 phr. Both the first elastomer composition for the elongate body 12 and the rubber composition for the strip were blended in accordance with conventional rubber blending practices, i.e., the compositions were blended in a Banbury mixer having an inner capacity of less than about 200 lbs and in a two pass mix configuration. In the first pass, the NR latex together with the process aid, the filler, the antioxidant/antiozonant and the PTFE were added to the Banbury and mixed to a temperature in the range of from about 310° F.±20° F., and the blend allowed to rest for twenty four hours. In the second pass, the curative, accelerator and desiccant were added, the so-formed composition mixed to a temperature in the range of 210° F.±10° F. The resultant uncured elastomer compositions for the elongate body 12 and the friction reducing strips 24, 26 were thereafter vulcanized in a co-extrusion process to form the resultant wiper blade, wherein the strip possessed a height 32 of about 1.5 mm, a thickness in the range of from about 0.10 mm to about 0.20 mm, and located at a distance in the range of from 0.5 to about 1.0 mm from the base portion apex 22. The highest portion of the strip 24, 26 was located as shown in FIG. 1 on the base portion 18 lateral surfaces 32, 34, and in general would not exceed the top edge of the base portion 18.

In the practice of this particular embodiment of the present invention it has been found that this incorporation of particulate friction reducing element in a vulcanized natural rubber strip 24, 26 generally adjacent the wiping surface lip portion 20 of a wiper blade 10 provides multiple benefits. First, the particulate PTFE in the amount and of the type (i.e., particle diameter) utilized in this particular example resulted in a plurality of optional protuberances 36 (shown in generally exaggeratedly enlarged form in FIG. 2), or areas raised from the otherwise substantially flat surface 38 of the strips 24, 26. These protuberances 36 generally comprised irregularly shaped- and sized masses, which are presently believed to be the result of an agglomeration or a plurality of PTFE particles massed together and not completely broken apart in the rubber mixing process to result in clumps in the otherwise generally homogeneous rubber matrix observable at the surface of the strip. Alternatively, it is believed that a particulate friction reducing element having a slightly larger average individual particle diameter, e.g., of greater than 10 μm and having a lesser tendency toward agglomeration could be utilized to result in individual protuberances of beneficial dimensions as further described below at the strip surface.

One of ordinary skill in the relevant art would readily recognize that if an undesirably high size- and or number of the optional protuberances 36 were located at or on the actual wiping surface 20 of the wiper blade, movement of the blade across a wet windshield would result in a series of undesirable streaks across the windshield surface. By incorporating these low coefficient of friction protuberances 36 near but not at the wiping surface 20 of the wiper blade in accordance with one embodiment of the present invention, the wipe quality during normal wiping conditions is not adversely impacted. When however the wiper blade encounters uneven- or low moisture conditions on the windshield surface, the base portion 18 drags, i.e., deflects rearward in relation to the blade's direction of motion as described above. The surface of the wiper blade in contact with the windshield surface changes thus to a point wherein the low coefficient of friction strip 24 (or 26) engages the windshield, thus reducing the effective friction between the blade 10 and the windshield. Moreover, the protuberances 36 in the strip 24, 26 provide an essentially rough- or irregular strip surface that beneficially results in a reduction of the area of actual contact between the wiper blade 10 and the windshield surface when the base portion is sufficiently deflected, which serves to reduce the surface tension therebetween. This in turn allows the non-PTFE containing wiping lip 20 to quickly re-engage the windshield to provide its intended water removal function as designed in accordance with this particular embodiment.

Secondly, the PTFE in the amounts and of the type employed in the composition of the strip described herein results in a beneficial reduced coefficient of friction in the strip 24, 26 over a broader operating temperature range than heretofore available. In particular, at a level of only 5 phr of the ZONYL 1500J material, the above-referenced optional protuberances as well as a significant reduction in coefficient of friction were obtained with no appreciable or significant increase in stiffness, i.e., decreased flexibility, in the NR wiper blade incorporating an NR-based strip in accordance with this particular embodiment of the present invention along either side of the wiping surface lip portion, even at temperatures as low as −20° C. At levels higher than those set forth above, and particularly at an incorporation level of PTFE of 15 phr, inferior wipe quality was observed which was believed to be attributable to the presence of an undesirably high number and/or size of protuberances at this level.

Alternatively, in the practice of a further embodiment of the present invention the above-described protuberances may be absent from the strip surfaces. It is presently believed that by increasing the mix efficiency, i.e., the speed and/or temperature and/or duration of mixing, of the elastomer composition for the strip, particularly but not necessarily during the first pass, and/or selecting a friction reducing element having a suitable combination of either individual particle size or particle agglomerate size and agglomerate resistance to being broken apart during the mixing process, the protuberances including those at the surface of the strip 18, 20 may be eliminated. This may be beneficial for example where one would desire a reduced coefficient of friction strip extending along the lateral surfaces 32, 34 of the base portion 18 but also extending substantially down to and optionally about the apex 22 of the base portion, such that the low-coefficient of friction strip forms the principal windshield-engaging surface of the wiper blade. This configuration is illustrated for example in FIG. 3, which furthermore illustrates an alternative embodiment of the present invention wherein the top-most portion of the strip 26 meets at the base portion to form a slight shoulder, as shown.

A further embodiment of the present invention is illustrated in FIG. 4. In accordance with this particular embodiment, the strips 24, 26 do not form a shoulder with either the base portion 18 or the wiping lip portion 20, but extend substantially to the apex 22 of the base portion 18. The particular embodiment of the present invention shown in FIG. 4 furthermore includes a backing member 40, which in the illustrated embodiment is in the form of a beam-type pre-curved spring backing member as disclosed for example in aforementioned U.S. Pat. No. 5,325,564. The wiping blade 10 in this illustrated embodiment is engaged to the backing member 40 in this particular embodiment through an adhesive layer 42 located at the interface therebetween, as is well known in the art.

Although the present invention has been described in detail for the purpose of illustration, it is to be understood that such detail is solely for that purpose and that variations can be made therein by one skilled in the art without departing from the spirit or scope of the present invention except as it may be limited by the appended claims. The invention disclosed herein may suitably be practiced in the absence of any element not specifically disclosed herein.

What is claimed is:

1. A wiper blade comprising an elongate cured rubber body having an upper grooved portion adapted for engagement with a backing member for maintaining the wiper blade in position; a base portion disposed along the grooved portion and comprising a wiping surface lip portion comprising the apex of the base portion; at least one strip extending along at least a portion of the length of the base portion on one side of the wiping surface lip portion, the strip portion comprising a first vulcanized composition formed of a first base rubber and from about 1 to about 10 phr of a friction reducing element.

2. The wiper blade of claim 1 wherein the friction reducing element forms a plurality of protuberances on an outward facing surface of the strip for reducing the surface contact between the strip and a windshield surface with deflection of the blade, whereby the surface tension between the windshield and the strip is reduced, and re-engagement of the wiping surface lip portion and the windshield surface is facilitated.

3. The wiper blade of claim 2 wherein the strip is spaced from the base portion apex by a distance.

4. The wiper blade of claim 3 comprising two said strips, each said strip extending along at least a portion of the length of the base portion, one on either side of the wiping surface lip portion.

5. The wiper blade of claim 1 wherein said friction reducing element comprises a material selected from a fluoropolymer, molybdenum disulfide, graphite and a combination of any of at least two of the foregoing

6. The wiper blade of claim 5 wherein said friction reducing element possesses at least one of an average particle diameter and an average particle agglomerate diameter of at least about 1 μm.

7. The wiper blade of claim 5 wherein said friction reducing element possesses at least one of an average particle diameter and an average particle agglomerate diameter in the range of from about 5 μm to about 100 μm.

8. The wiper blade of claim 5 wherein said friction reducing element comprises said fluoropolymer possessing at least one of an average particle diameter and an average particle agglomerate diameter in the range of from about 10 μm to about 50 μm.

9. The wiper blade of claim 1 wherein said first base rubber of said first vulcanized composition is one selected from natural rubber, natural rubber latex, chloroprene rubber, styrene butadiene rubber, ethylene alpha olefin elastomer, polybutadiene, silicone rubber, acrylonitrile butadiene rubber, hydrogenated acrylonitrile butadiene rubber, urethane and a combination of any of at least two of the foregoing.

10. The wiper blade of claim 1 wherein said first vulcanized composition comprises from about 2 to about 8 phr of said friction-reducing element.

11. The wiper blade of claim 1 wherein said base portion is formed of a second vulcanized composition comprising a second base rubber selected from natural rubber, chloroprene rubber, styrene butadiene rubber, ethylene alpha olefin elastomer, polybutadiene, silicone rubber, acrylonitrile butadiene rubber, hydrogenated acrylonitrile butadiene rubber, urethane and a combination of any of at least two of the foregoing.

12. The wiper blade of claim 11 wherein at least one of said second base rubber and said first base rubber comprises at least one of natural rubber and natural rubber latex.

13. The wiper blade of claim 2 wherein at least one of said protuberances comprises an agglomerate of at least two particles of said friction-reducing element.

14. The wiper blade of claim 13 wherein said agglomerate of said friction reducing element particles possess an average particle agglomerate diameter in the range of from about 10 μm to about 35 μm.

15. The wiper blade of claim 1 wherein said strip extends at least substantially to said apex of said base portion.

16. A wiper assembly comprising the wiper blade of claim 1 and said backing member engaged to said blade at said upper grooved portion.

17. A wiper blade comprising an elongate cured rubber body formed of a natural rubber composition and having an upper grooved portion adapted for engagement with a backing member for maintaining the wiper blade in position; a base portion disposed along the grooved portion and comprising a wiping surface lip portion comprising the apex of the base portion; a first strip extending along at least a portion of a first base portion lateral surface proximal said wiping surface lip portion, and a second strip extending along at least a portion of an opposite second base portion lateral surface proximal said wiping surface lip portion, at least one said strip portion comprising a first vulcanized composition formed of a natural rubber latex and from about 1 to about 10 phr of a friction reducing element comprising particulate polytetrafluoroethylene having an average particle agglomerate diameter in the range of from about 10 μm to about 35 μm, at least a portion of said friction reducing element forming at least one protuberance on an outer surface of at least one said strip portion.
